(19) United States
(12) Patent Application Publication
(10) Pub. No.: US 2014/0012604 A1
(43) Pub. Date: Jan. 9, 2014

(54) Self-Selected Insurance Pool Management

(71) Applicant: David W. Allen, JR., San Francisco, CA (US)

(72) Inventor: David W. Allen, JR., San Francisco, CA (US)

(21) Appl. No.: 13/544,659

(22) Filed: Jul. 9, 2012

(51) Int. Cl. G06Q 40/08

(52) U.S. Cl. 705/4

(57) ABSTRACT

In some implementations, a self-selected insurance pool can be created. A group organizer and/or member of the insurance pool can invite friends, relatives and/or other contacts to join the self-selected insurance pool. Invitations can be sent using electronic mechanisms, including email, instant messaging, text messaging, etc. Invitees can be identified and selected from a member's address book or from contacts on a social media website. In some implementations, once the insurance pool has been created, members of the pool can monitor the activities of members of the group and receive notifications of events generated by other members. Members of the pool can view their own statistics as compared to other members of the group. Members can initiate a review of another member to determine if the member has been abusing or excessively using the insurance of the pool and initiate proceedings to remove the abusing member from the pool.

### TECHNICAL FIELD

The disclosure generally relates to insurance management.

### BACKGROUND

Insurance (e.g., car insurance, health insurance, etc.) is a mechanism by which the cost of accidents, illness, etc., can be spread across a group of people. To obtain discounts on rates and other benefits, insurance is often purchased by a group of people. For example, the group of people can be employees of a company who purchase health insurance together as a group. However, there is no accountability or visibility into how other members of an insured group utilize or possibly abuse the insurance obtained for the group. Moreover, there are no incentives to encourage responsible use of the group's insurance.

### SUMMARY

In some implementations, a self-selected insurance pool can be created. A group organizer and/or member of the insurance pool can invite friends, relatives and/or other contacts to join the self-selected insurance pool. Invitations can be sent using electronic mechanisms, including email, instant messaging, text messaging, etc. Invitees can be identified and selected from a member's address book or from contacts on a social media website.

In some implementations, once the insurance pool has been created, members of the pool can monitor the activities of members of the group and receive notifications of events generated by other members. For example, members can view the insurance claims submitted by other members of the group. Members of the pool can view their own statistics as compared to other members of the group. Members can initiate a review of another member to determine if the member has been abusing or excessively using the insurance of the pool and initiate proceedings to remove the abusing member from the pool.

Particular implementations provide at least the following advantages: An insurance pool can be created where the members of the pool are accountable to each other. Visibility into member's activities can prevent abuse and escalation of the costs associated with obtaining insurance. A member can see how the member is performing relative to other members of the insurance pool and adjust his or her behavior to obtain better insurance rates. Abusive members can be removed from the insurance pool to keep the costs of insurance down.

Details of one or more implementations are set forth in the accompanying drawings and the description below. Other features, aspects, and potential advantages will be apparent from the description and drawings, and from the claims.

### DESCRIPTION OF DRAWINGS

FIG. 1 illustrates an example system for creating and managing a self-selected insurance pool.

FIG. 2 illustrates an example graphical user interface for managing a self-selected insurance pool.

FIG. 3 illustrates an example graphical user interface for presenting status information for the insurance pool.

FIG. 4 illustrates an example graphical user interface for presenting information about a member of the insurance pool.

FIG. 5 illustrates an example graphical user interface for presenting alerts.

FIG. 6 illustrates an example graphical user interface for submitting insurance metrics for a member of the insurance pool.

FIG. 7 illustrates an example graphical user interface for comparing metrics of the insurance pool to metrics of an individual member.

FIG. 8 illustrates an example graphical user interface for comparing metrics of the insurance pool to metrics of an individual member.

FIG. 9 illustrates an example graphical user interface for comparing historical metrics of the insurance pool to historical metrics of an individual member.

FIG. 10 illustrates an example graphical user interface displaying detailed information for members of the insurance pool for a selected month.

FIG. 11 illustrates an example graphical user interface for comparing a member's metrics to the metrics of the insurance pool.

FIG. 12 is a flow diagram of an example method for self-selected insurance pool management.

FIG. 13 is a block diagram of an exemplary system architecture implementing the features and processes of FIGS. 1-12.

Like reference symbols in the various drawings indicate like elements.

### DETAILED DESCRIPTION

This disclosure describes various Graphical User Interfaces (GUIs) for implementing various features, processes or workflows. These GUIs can be presented on a variety of electronic devices including but not limited to laptop computers, desktop computers, computer terminals, television systems, tablet computers, e-book readers and smart phones. One or more of these electronic devices can include a touch-sensitive surface. The touch-sensitive surface can process multiple simultaneous points of input, including processing data related to the pressure, degree or position of each point of input. Such processing can facilitate gestures with multiple fingers, including pinching and swiping.

When the disclosure refers to “select” or “selecting” user interface elements in a GUI, these terms are understood to include clicking or “hovering” with a mouse or other input device over a user interface element, or touching, tapping or gesturing with one or more fingers or stylus on a user interface element. User interface elements can be virtual buttons, menus, selectors, switches, sliders, scrubbers, knobs, thumbnails, links, icons, radial buttons, checkboxes and any other mechanism for receiving input from, or providing feedback to a user.

### Insurance Pool Formation

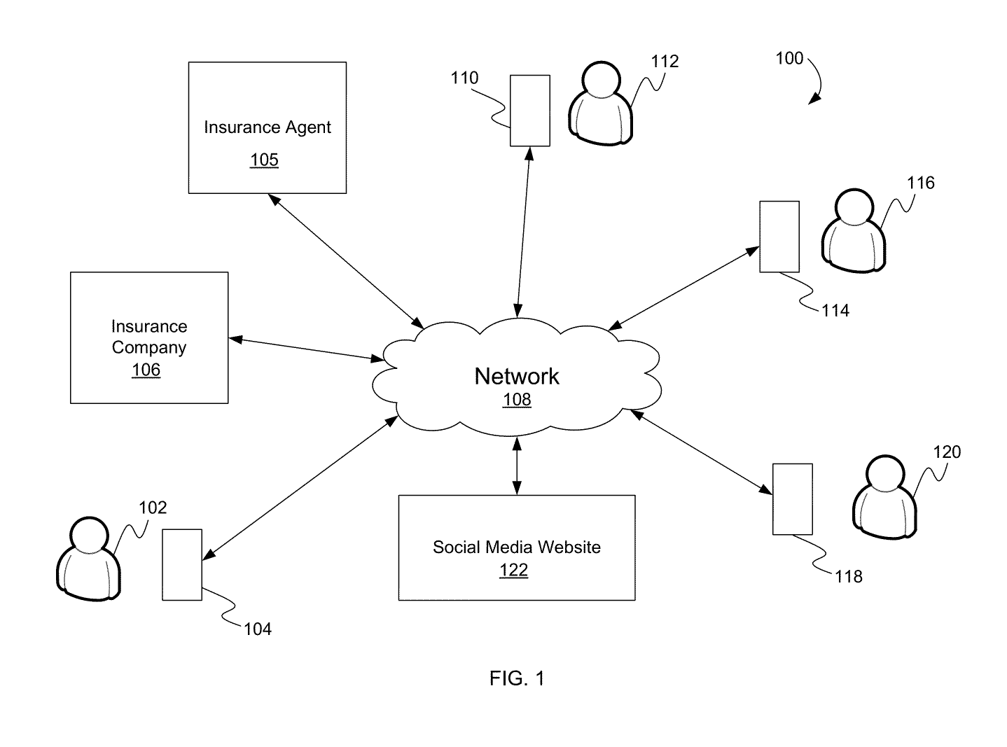

FIG. 1 illustrates an example system 100 for creating and managing a self-selected insurance pool. In some implementations, user 102 can create a new insurance pool by using computing device 104 to communicate with insurance agent 105 or insurance company server 106 through network 108. For example, computing device 104 can be a mobile device, cellular telephone, smartphone, tablet computer, laptop computer, or any other computing device. Network 108 can be a local area network, the internet, or any other network for connecting computing devices. The insurance pool can be created to allow a group of people (e.g., friends, family, contacts, etc.) to negotiate and obtain insurance as a group thereby reducing the cost of insuring each individual member of the group.

In some implementations, once the insurance pool is created, user 102 can invite other users to become members of the insurance pool. For example, user 102 can invite user 112 to become a member of the insurance pool by sending an email to user 112 which user 112 can view and respond to on computing device 110. User 102 can send an instant message or text message to computing device 114 to invite user 116 to join the insurance pool, for example.

In some implementations, user 102 can invite contacts through social media website 122 to join the insurance pool. For example, user 120 may be a contact associated with user 102 through social media website 122. User 120 can invite user 120 to join the insurance pool through messages transmitted through social media website 122. User 120 can view and respond to the messages using mobile device 118.

In some implementations, when a user (e.g., user 112, 116, or 120) receives an invitation to join the insurance pool, the user can be directed to a user interface (e.g., webpage) of insurance agent 105 or insurance company server 106. The user can use the user interface to submit an application containing personal information for consideration by the insurance company and/or insurance agent and by current insurance pool members. In some implementations, a new application to join the insurance pool may not be accepted until the current members of the insurance pool accept the new application. In some implementations, the application only needs to be accepted by the insurance company or the insurance agent. Once the application is accepted, the invitee will become a member of the insurance pool.

In some implementations, insurance agent 105 can manage the creation and insuring of the insurance pool. For example, insurance agent 105 can receive individual applications to join the insurance pool and transmit the information about the individual members to one or more insurance companies. The insurance companies can provide quotes or make bids on insurance rates and insurance coverage (e.g., terms of the insurance policy) for the insurance pool. In some implementations, insurance agent 105 can work with specific insurance companies based on a classification associated with the insurance pool. For example, an insurance pool that is comprised of high risk individuals can be presented to an insurance company that specializes in insuring high risk individuals.

### Insurance Pool Management

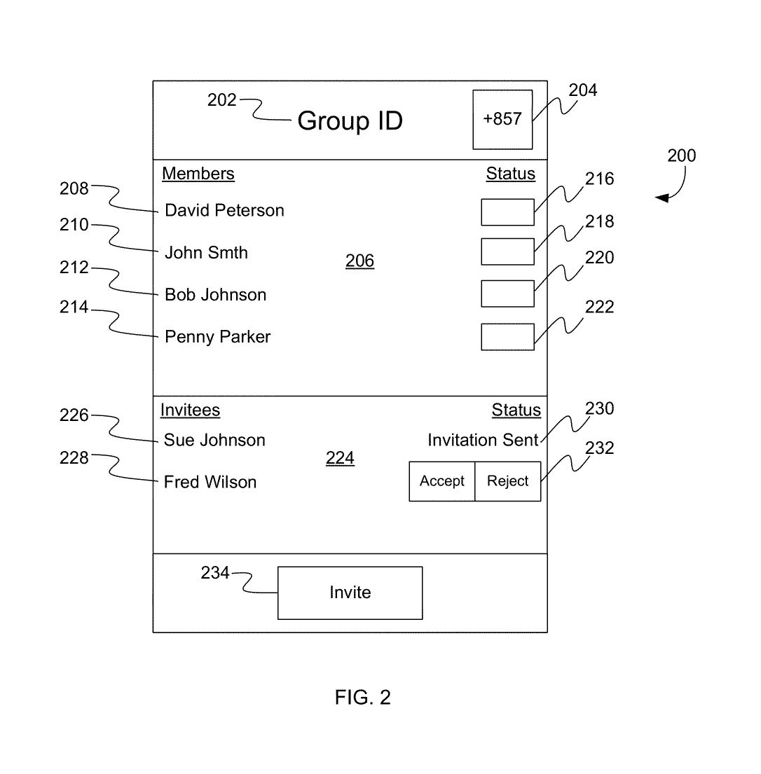

FIG. 2 illustrates an example graphical user interface 200 for managing a self-selected insurance pool. For example, a member of the insurance pool can login to a website or an application associated with the insurance company or insurance agent to view information about the insurance pool. When the member logs in, user interface 200 can be displayed. To differentiate a logged in member from another member, the logged in member can be referred to as the user or current user, below. In some implementations, user interface 200 can include an identifier 202 for the insurance pool. Identifier 202 can be a name assigned to the insurance pool (e.g., the name of the organizer) or an identifier for the insurance policy for the insurance pool, for example.

In some implementations, user interface 200 can include insurance pool status indicator 204. For example, indicator 204 can display different colors (e.g., red, green, yellow) based on the overall status of the insurance pool. For example, if the members of the insurance pool are behaving responsibly (e.g., not filing many claims, not getting many traffic tickets, etc.) then indicator 204 can display a green color. If a member of the group has recently received a traffic ticket or filed a claim, indicator 204 can display a yellow color indicating an event that may adversely affect the insurance pool has occurred. If a member of the insurance pool has behaved in a way that may cause the insurance premiums to increase or the insurance to be canceled, indicator 204 can display a red color, for example.

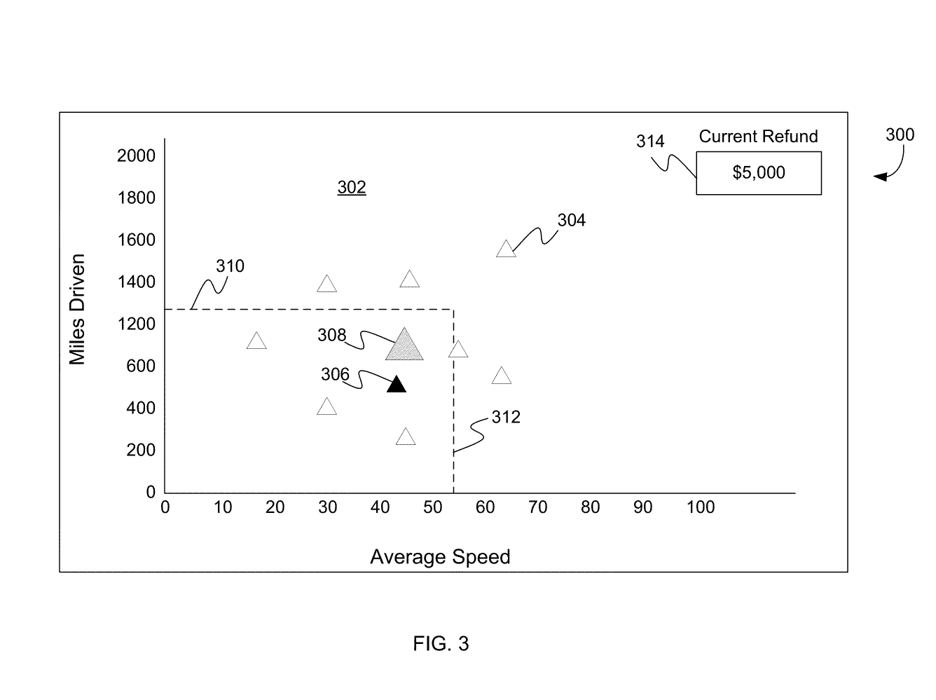

In some implementations, indicator 204 can display a number indicating the number of days that have passed since the last adverse event. For example, if no claim, traffic ticket, accident, or other event has occurred for 857 days, then indicator 204 can display the number 857 to indicate when the last adverse event occurred. Indicator 204 can be used, for example, to encourage members to drive carefully and/or act in a careful and responsible manner. In some implementations, indicator 204 can be selected to cause user interface 300 of FIG. 3 to be displayed.

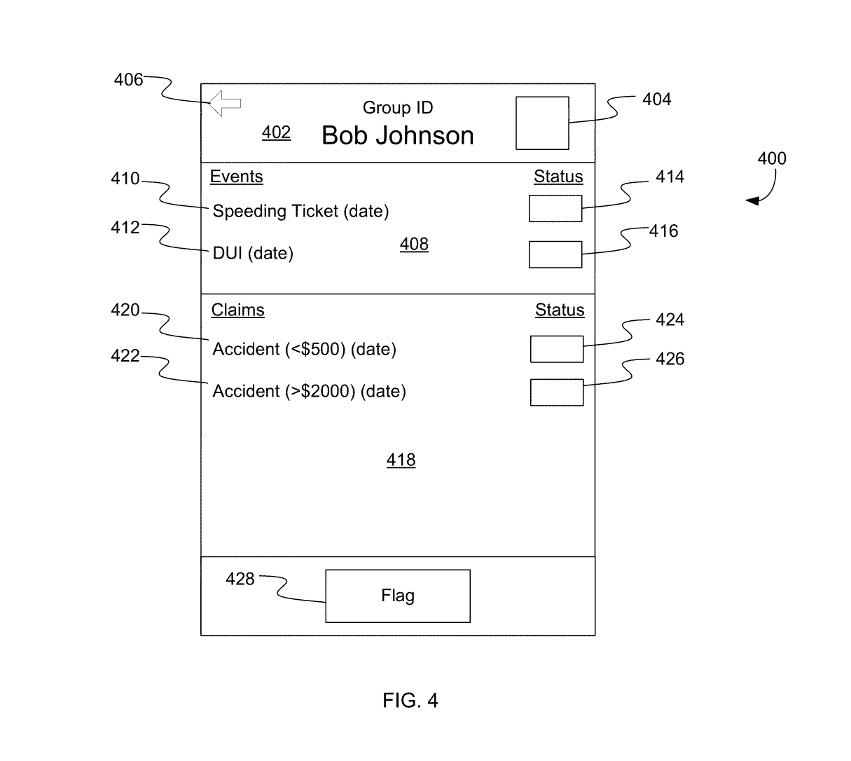

In some implementations, user interface 200 can include an identification of insurance pool members. For example, area 206 can include the names, user names, pseudonyms, etc. (e.g., items 208-214) of current members of the insurance pool. Each member identifier can have a corresponding status indicator (e.g., status indicators 216-222). For example, if member 208 (David Peterson) is not associated with any adverse events for a period of time (e.g, 1 year), corresponding status indicator 216 can present a green color. If member 210 (John Smith) has a minor infraction (e.g., parking ticket) or a low number of adverse events (e.g., 1 event in a one year period), then corresponding status indicator 218 can present a yellow color, for example. If member 212 (Bob Johnson) is associated with greater than a threshold number of adverse events or with particularly bad adverse events (e.g., a costly claim that exceeds a threshold amount, a serious moving violation such as driving under the influence, etc.), then corresponding status indicator 220 can present a red color. In some implementations, member identifiers 208-214 and/status indicators 216-222 can be selected to cause user interface 400 of FIG. 4 to be displayed, as described further below.

In some implementations, user interface 200 can include area 224 for displaying invitee information. For example, area 224 can include identifiers 226-228 (e.g., names) of people who have been invited to join the insurance pool. Each invitee identifier can have a corresponding status indicator 230-232. For example, the status indicators can indicate that an invitation has been sent to the invitee, that an application has been submitted by the invitee or that the invitee's application is pending review. In some implementations, the invitee identifier (e.g., 226 or 228) and/or status indicator (e.g., 230) can be selected to view the invitee's information. For example, selection of the invitee identifier and/or status indicator can cause the invitee's application containing the invitee's personal information to be displayed.

In some implementations, the invitee's identifier and/or status indicator can be selected (e.g., swipe gesture, hover with cursor, etc.) to cause the status indicator to change to an accept/reject graphical object 232. For example, the accept/reject graphical object 232 can be manipulated to allow the user to vote to accept or reject the invitee's application to join the insurance pool. In some implementations, the invitee's status will automatically change to display the accept/reject graphical object 232 when the invitee's application is presented to the members of the insurance pool to vote on accepting the invitee as a member of the insurance pool.

In some implementations, user interface 200 can include graphical object 234 for inviting a new person to join the insurance pool. For example, a user/member can select graphical object 234 to cause a graphical object to be displayed for entering contact information for the new invitee. For example, the user can provide an email address or social media website identifier of the new invitee and an email or message can be sent to the new invitee to invite him or her to join the insurance pool. In some implementations, the invitee contact information can be sent to the insurance agent or insurance company and the insurance agent or company can forward the request to the new invitee along with a link to the insurance provider's web-based application so that the invitee can submit an application to join the insurance pool upon selecting the link.

FIG. 3 illustrates an example graphical user interface 300 for presenting status information for the insurance pool. In some implementations, graphical user interface 300 can present a bivariate chart 302 depicting average speed and cumulative distance travelled during a time period (e.g., one month). In some implementations, graphical user interface 300 can present other bivariate charts depicting number of claims, claim amounts, traffic infractions and/or other metrics for a time period. In some implementations, chart 302 can present graphical indicators (e.g., 304) representing statistics associated with individual members of the insurance pool. Chart 302 can include a graphical indicator 308 representing the cumulative statistics (e.g., average) of the insurance pool. Chart 302 can include a graphical indicator 306 representing the statistics associated with the user who is viewing or logged into user interface 300.

In some implementations, chart 302 can include (e.g., display) threshold lines 310 and 312. For example, threshold line 310 can represent a threshold number of miles driven by a member. If the cumulative or average number of miles driven by the members of the insurance pool is below the threshold number of miles represented by line 310, then the insurance pool may be eligible for discounts on insurance premiums. Similarly, threshold line 312 can represent a threshold speed value. For example, if the average driving speed of members of the insurance pool is less than the threshold speed value, the insurance pool may be eligible for discounts on insurance premiums. Lines 310 and 312 can represent threshold values for number of claims, claim amounts, traffic infractions and/or other metrics, for example.

Chart 302 can provide a mechanism that allows a user to quickly determine which members of the pool are behaving in a way that benefits the insurance pool (e.g., member associated with graphical indicator 306), which members of the pool are adversely affecting the insurance pool (e.g., member associated with graphical indicator 304) and the status of the pool as a whole (e.g., graphical indicator 308). For example, because graphical indicator 308 is within the region delineated by lines 310 and 312, the insurance pool may be eligible for discounts, bonuses, or other benefits from the insurance company.

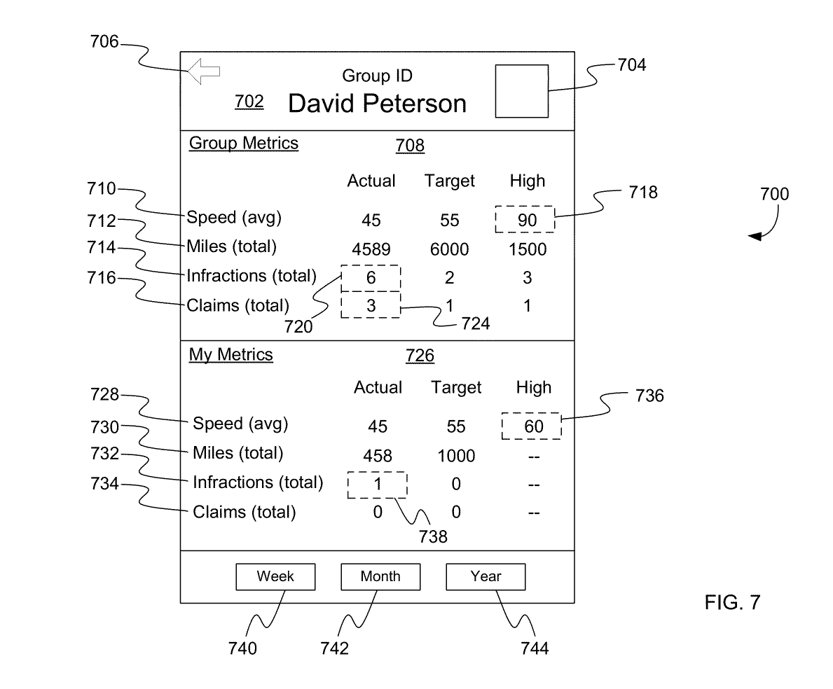

In some implementations, graphical indicators 304 and/or 306 are selectable to view information associated with the individual member associated with the selected graphical indicator. For example, if graphical indicator 304 represents member Bob Johnson, then selection of graphical indicator 304 can cause graphical user interface 400 including information associated with Bob Johnson to be displayed, as described with reference to FIG. 4 below. In some implementations, when the user selects graphical indicator 306 representing the user, graphical user interface 700 of FIG. 7 can be displayed.

In some implementations, graphical user interface 300 can include graphical object 314 for indicating the current refund, rebate, bonus, dividend, etc., that the insurance pool is eligible for. For example, if the insurance pool is performing within the limits indicated by lines 310 and 312, then the bonus amount indicated by graphical object 314 may increase over time. If the insurance pool exceeds threshold values indicated by lines 310 and 312, the bonus amount indicated by graphical object 314 may decrease over time. Thus, the bonus amount indicated by graphical object 314 may change based on the location of indicator 308 within chart 302.

FIG. 4 illustrates an example graphical user interface 400 for presenting information about a member of the insurance pool. For example, graphical user interface 400 can be invoked by selecting status indicator 220 of FIG. 2 or graphical indicator 304 of FIG. 3. In some implementations, graphical user interface 400 can include information area 402. For example, information area 402 can include an identifier for the insurance pool (e.g., Group ID), the name of the member currently displayed (e.g., Bob Johnson), and/or status indicator 404.

In some implementations, status indicator 404 can display a color (e.g., red, green, yellow) based on the number and/or severity of adverse events associated with the displayed member. For example, if Bob is a good driver with no tickets, claims, etc., then status indicator 404 can display a green color. However, if Bob has a minor infraction (e.g., a speeding ticket) or a minor accident (e.g., a claim less than a threshold dollar amount), then status indicator 404 can display a yellow color. If Bob is involved with many adverse or severe events (e.g., driving under the influence, a claim greater than a threshold dollar amount), status indicator 404 can display a red color indicating that Bob is a high risk for the insurance pool and may be subject to expulsion from the pool. Information area 402 can include selectable graphical object 406 which when selected causes the previously displayed user interface to be presented.

In some implementations, adverse events and claims can be assigned a number of points. For example, a minor traffic violation can correspond to one point. A major moving violation (e.g., driving under the influence) can correspond to ten points. Accident claims can be assigned points based on the dollar amount of damage claimed (e.g., one point per thousand dollars). The overall status of a member can be based on the total number of points associated with the member. For example, if a member has a total number of points below a good standing threshold (e.g., less than 20), the member can be considered to be in good standing with the pool and status indicator 404 can display a green color. If the member has a total number of points above the good standing threshold but below an expulsion threshold (e.g., greater than 20 but less than 60), the member can be warned that the member is no longer in good standing by presenting a yellow color on status indicator 404. If the member has a total number of points above the expulsion threshold (e.g., greater than 60), then the member can be flagged as an expulsion candidate and status indicator 404 can display a red color.

In some implementations, graphical user interface 400 can include event information area 408. For example, area 408 can present descriptions of events 410 and 412 (e.g., speeding tickets, arrests, other infractions) associated with Bob Johnson and status indicators 414 and 416. For example, status indicators 414 and 416 can display colors (e.g., red, green, yellow) indicating the severity of a corresponding event. For example, status indicator 414 can display a yellow color indicating that event 410 (speeding ticket) is a low severity event. Status indicator 416 can display a red color indicating that event 412 (driving under the influence) is a high severity event. The severity (and color) can correspond to the number of points associated with the event, as described above.

In some implementations, graphical user interface 400 can include claims information area 418. For example, area 418 can display descriptions of claims 420 and 422 associated with Bob Johnson and status indicators 424 and 426. For example, status indicator 424 can display a yellow color (e.g., low severity) for an accident claim that is less than a threshold dollar amount. Status indicator 426 can display a red color (e.g., high severity) for an accident claim that is greater than a threshold dollar amount.

In some implementations, graphical user interface 400 can include a selectable graphical object 428 that allows a user to flag a member of the pool for review. For example, the user may wish to flag a member who is associated with too many adverse events or claims. In some implementations, flagging a member can trigger a review of the member by other members of the insurance pool and can lead to a vote to expel the flagged member from the insurance pool.

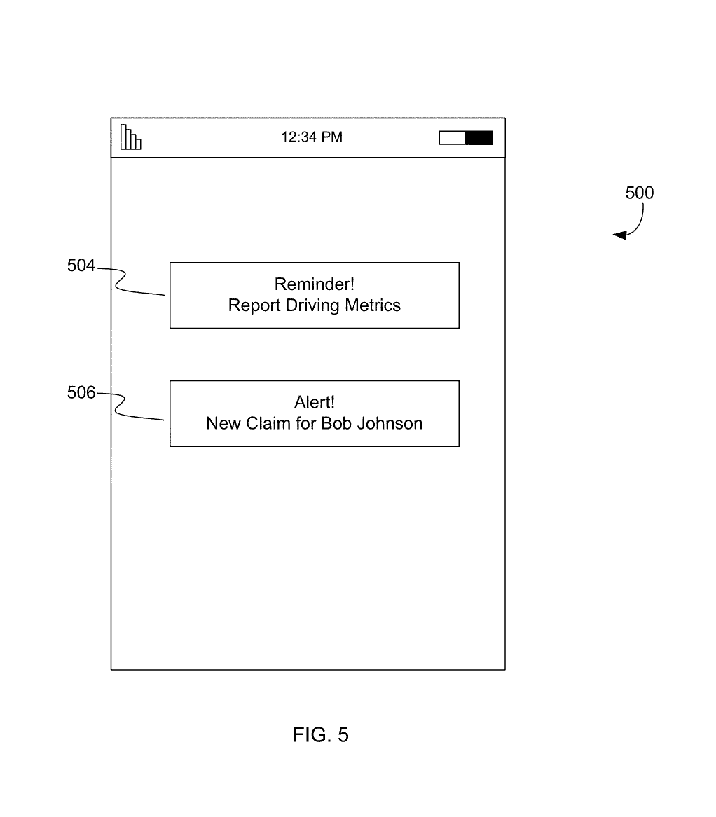

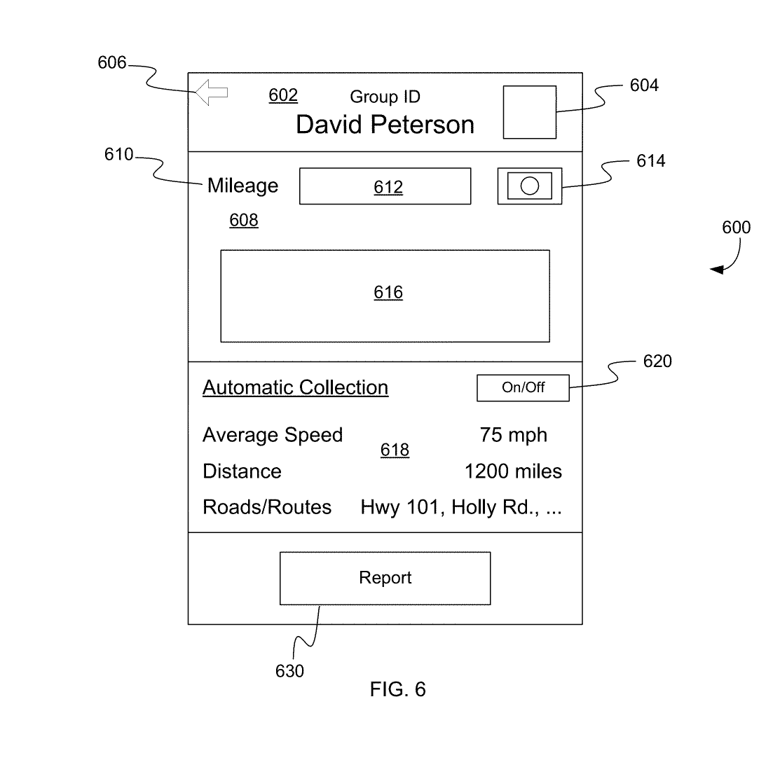

FIG. 5 illustrates an example graphical user interface 500 for presenting alerts for the insurance pool. For example, an application running on a mobile device can receive notifications from the insurance agent's or insurance company's server when member action is required or when a change of status has occurred with respect to one or more members of the insurance pool. For example, graphical user interface 500 can be a lock screen or standby screen of a mobile device. In some implementations, graphical user interface 500 can display reminder 504. For example, reminder 504 can be presented to remind the member that the member should provide information (e.g., driving metrics, updated personal information such as new home address, etc.) to the insurance agent and/or company. In some implementations, the user can select reminder 504 to cause graphical user interface 600 of FIG. 6 to be displayed.

In some implementations, alert 506 can be displayed to draw the user's attention to a new claim or event associated with another member of the insurance pool. For example, if Bob Johnson files a new accident claim, other members of the insurance pool can be notified of the newly submitted claim by presenting alert 506. Alerts can be presented in response to detecting new events (e.g., tickets) and/or new claims, for example. In some implementations, the user can select alert 506 to display user interface 400 and view the events and claims associated with alert 506.

### Metrics Reporting

FIG. 6 illustrates an example graphical user interface 600 for submitting insurance metrics for a member of the insurance pool. In some implementations, graphical user interface 600 can include information area 602. For example, information area 602 can include an identifier (e.g., name) for the member (e.g., user, current user) currently logged into the mobile device or logged into the insurance agent and/or company application or website. Information area 602 can include the insurance pool identifier for the insurance pool to which the identified member belongs. Information area can include member status indicator 604. For example, status indicator 604 can indicate the current status (e.g., red, green, yellow colors) of the displayed member, as described with reference to status indicator 404 of FIG. 4. In some implementations, a user can select graphical object 606 to return to the previously displayed user interface.

In some implementations, graphical user interface 600 can include manual metric submission area 608. For example, area 608 can include metric identifier 610 that identifies metric information (e.g., mileage) that is being submitted by the member. Area 608 can include a text entry area 612 for entering data for the identified metric. For example, if the metric being reported by the member is mileage, then the member can enter a number representing the current mileage displayed on the odometer of the member's vehicle. The member can select text entry area 612 to cause a virtual keyboard to display (not shown) and enter the odometer mileage using the virtual keyboard to cause the mileage input to be displayed in text entry area 612.

In some implementations, the member can provide proof of a reported metric using user interface 600. For example, the member can select graphical object 614 to invoke camera functionality of the computing device. The member can take a photograph of the odometer of the vehicle and submit the photograph as evidence that the member has reported the correct odometer reading. The photograph can be displayed in area 616 once the photograph has been taken.

In some implementations, graphical user interface 600 can include automatic metric collection area 618. In some implementations, area 618 can include selectable graphical object 620 for turning on and off automatic metric collection. For example, graphical object 620 can be an on/off toggle for turning on and off automatic data collection. In some implementations, when automatic data collection is turned on, the computing device can automatically collect driving metrics while the member is driving a vehicle. For example, the vehicle can be equipped with a short distance transmitter (e.g., radio frequency transmitter, Bluetooth transmitter, near field communications transmitter, etc.) for transmitting signals. The transmitter can be part of the vehicle or a device that is plugged into a power port or attached to the vehicle. For example, the transmitter can be part of a device that can be plugged into a cigarette lighter or power port of the vehicle. The computing device can be equipped with a receiver that can detect the signals. When the member nears the vehicle, the computing device can receive the signals from the vehicle's transmitter and, in response to receiving the signals, begin monitoring movement of the computing device as the member operates the vehicle. When the member leaves the vehicle (e.g., the computing device no longer receives the signals), the computing device can stop monitoring the movement of the computing device.

In some implementations, the movement of the computing device can be detected using sensors (e.g., global navigation satellite system (GNSS) receivers, accelerometer, compass, etc.) of the computing device. For example, the computing device can determine a location of the computing device based on GNSS signals. As the member drives a vehicle, the location of the computing device will change. The change of location over time can be used to determine speed and distance. Moreover, the GNSS data can be compared to map data to determine specific roads and routes traveled by the member. Additionally, day and time information can be gathered to determine when the member operates the vehicle. In some implementations, the automatically collected information for a reporting period (e.g., monthly, weekly, etc.) can be displayed in area 618.

In some implementations, graphical user interface 600 can include selectable graphical object 630 for reporting the member's metrics. For example, the member can select graphical object 630 (e.g., a button) to cause the member's metrics to be sent to the insurance agent's and/or company's servers for use in determining insurance risk and rates for the insurance pool to which the member belongs.

In some implementations, member metrics can be reported automatically. For example, metrics can be collected automatically, as described above, and reported automatically according to a predetermined schedule (e.g., weekly, monthly, yearly, etc.). The predetermined schedule can be configured by the user of the computing device. The predetermined schedule can be a schedule specified by the insurance agent or insurance company as part of the agreed upon insurance policy.

### Viewing and Comparing Metrics

In some implementations, the metrics displayed on the graphical user interfaces of FIGS. 2-11 can be transmitted to the user's computing device from one or more servers of an insurance agent or insurance company associated with the insurance pool. For example, once metrics of individual members of the insurance pool are reported to the insurance agent and/or insurance company, the metrics can be made available to other members of the insurance pool through the graphical user interfaces of FIGS. 2-11.

FIG. 7 illustrates an example graphical user interface 700 for comparing metrics of the insurance pool to metrics of an individual member (e.g., the current user). For example, graphical user interface 700 can be invoked by selecting status indicator 216 of FIG. 2 and/or indicator 306 of FIG. 3. Graphical user interface can present information for an insurance pool member who is currently logged into the mobile device, logged into an application installed on the mobile device, or logged into a website of the insurance agent or company. In some implementations, graphical user interface 700 allows a member to view the member's own statistics and make comparisons to the statistics of the insurance pool as a whole (e.g., averages, totals, etc., for various metrics collected for the insurance pool and its members).

In some implementations, graphical user interface 700 can include information area 702 that includes an identifier for the insurance pool and/or an identifier for a member of the insurance pool. Information area 702 can include status indicator 704 for indicating the current status of the displayed member. For example, status indicator can display colors (e.g., red, green, yellow) indicating the member's status or standing within the insurance pool, as described above. Information area 702 can include graphical object 706 that is selectable to invoke (e.g., return to) a previously displayed user interface.

In some implementations, graphical user interface 700 can include pool metrics area 708. For example, area 708 can present metrics for the insurance pool as a whole (e.g., averages, totals, etc.). Area 708 can present metrics including average speed 710, total miles driven 712, total number of infractions 714 (e.g., tickets, moving violations, etc.) and/or total number of claims 716 filed for the insurance pool. The displayed metrics can include the actual values, a target value and the high value for each metric. For example, the actual value can be the calculated average or total for the insurance pool. The target value can be a threshold value where, if the insurance pool stays below (or above) the threshold value, the insurance pool can obtain some benefit (e.g., discount, refund, etc.). The high value can be a value associated with a single individual (e.g., the highest speed metric observed, the highest number of miles driven, the highest number of infractions, the most number of claims, etc.). In some implementations, a member can select a value in the high value column to view information associated with the member associated with the high value. For example, selection of a high value can invoke graphical user interface 400 of FIG. 4.

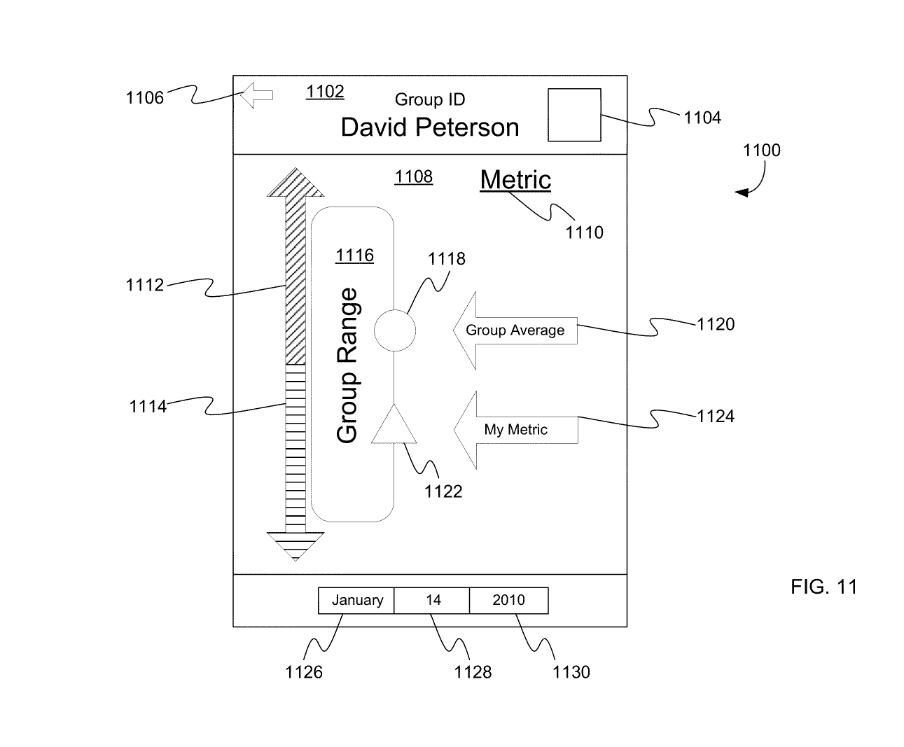

In some implementations, group metrics can be highlighted. For example, if high value 718 is above a threshold value, the value 718 can be highlighted with a background color (e.g., yellow, red) indicating the severity or risk associated with the metric. If the actual value 720, 724 associated with a metric exceeds the target value for the metric, the actual values 720 and 724 can be highlighted with a background color (e.g., yellow, red, etc.) to indicate that the metrics exceeding the target values may result in an increase in insurance premiums or some other change in the insurance policy for the insurance pool. In some implementations, a member can select a metric (e.g., 710, 712, 714 and/or 716) to invoke graphical user interface 1100 of FIG. 11.

In some implementations, graphical user interface 700 can include individual member metrics information area 726. For example, area 726 can present information about the currently logged in member. Area 726 can present information indicating the actual, target and high values associated with the member for each metric. The values can be averages, totals or other cumulative values for a metric collection period (e.g., week, month, year, etc.). The metrics can include speed 728, miles driven 730, total number of infractions 732 and/or number of claims 734 filed. In some implementations, a member can select a metric (e.g., 728, 730, 732 and/or 734) to invoke graphical user interface 1100 of FIG. 11. As described above, metric values can be highlighted when a high value 736 exceeds a threshold value or when the actual value 738 exceeds a target value.

In some implementations, graphical user interface 700 can include graphical objects 740, 742 and 744 to change the time period represented by the displayed metrics. For example, the member can select graphical object 740 to display metrics for the previous week. The member can select graphical object 742 to display metrics for the previous month. The member can select graphical object 744 to display metrics for the previous year. In some implementations, graphical user interface 700 can include an interface object (e.g., calendar) for specifying a time period to display. For example, the member can specify a date to view metrics collected since the specified date. The member can specify a date range (e.g., start and end dates) for which to show the collected metrics.

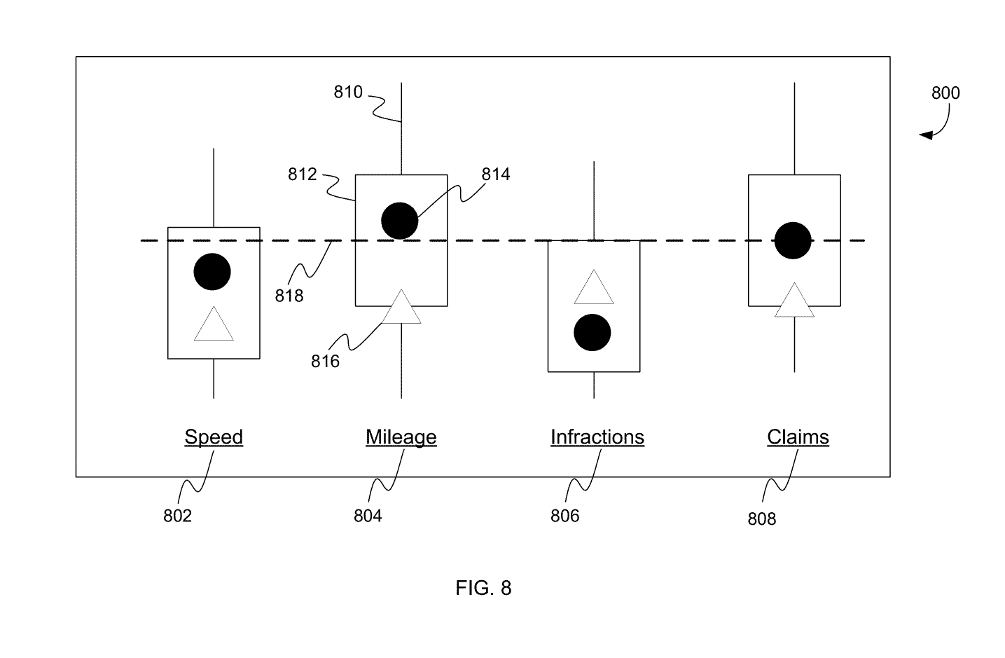

FIG. 8 illustrates an example graphical user interface 800 for comparing metrics of the insurance pool to metrics of an individual member. In some implementations, graphical user interface 800 can be invoked by rotating the computing device from a portrait orientation to a landscape orientation. For example, the computing device can be a mobile device with a built in accelerometer that can detect the movement and orientation of the mobile device. When the mobile device is rotated from a portrait orientation to a landscape orientation while displaying graphical user interface 700, graphical user interface 800 can be displayed.

In some implementations, graphical user interface 800 can present graphical objects for comparing individual member, pool average, pool range and general population metrics. For example, graphical user interface 800 can present graphics displaying metrics for speed 802, mileage 804, infractions 806 and/or claims filed 808. The metrics represented on graphical user interface can be the same metrics (or additional metrics) as displayed on graphical user interface 700. The graphics for each metric can include line 810 that indicates the range of values observed for the total population (or portion of the total population, age group, gender group, etc.) of people insured by the insurance company. Graphical object 812 can indicate the range of values observed for the insurance pool as a whole. For example, the range of values for the insurance pool can be a range of individual averages, sum totals or other cumulative value. Graphical object 814 can indicate an average value observed for members of the insurance pool for the metric. Graphical object 816 can indicate a value for an individual member (e.g., the currently logged in member or user). Target line 818 can represent a target value for insurance pool average and individual member values. For example, if the pool average 814 is below target line 818, then the insurance pool may be eligible for discounts or other benefits. Thus, by viewing graphical user interface 800 the member can quickly compare the user's metric values 816 to the average value for the members of the insurance pool 814 and to the range of values for the insurance pool 812 and the insured population 810.

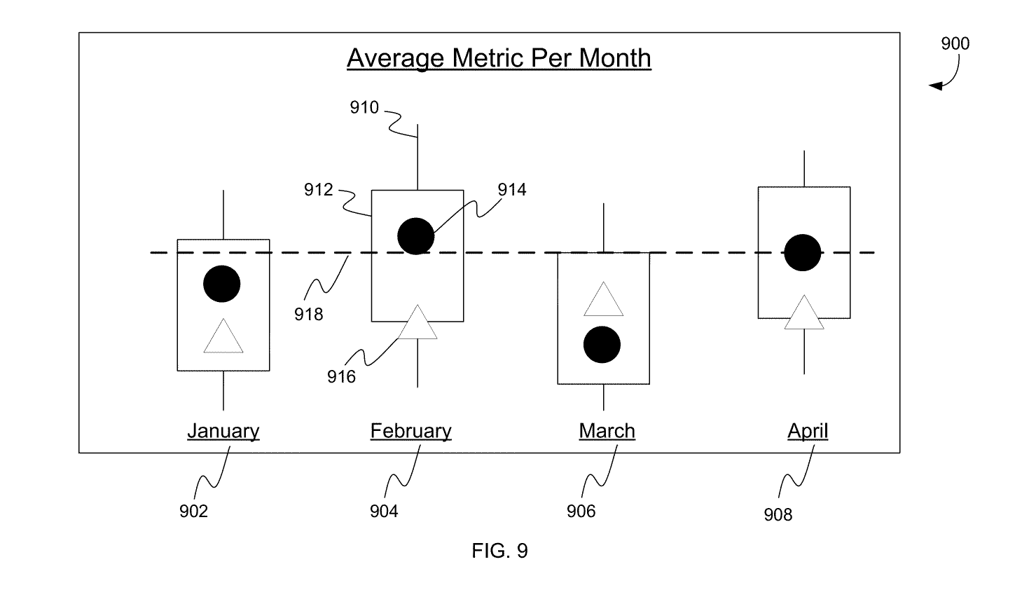

FIG. 9 illustrates an example graphical user interface 900 for comparing historical metrics of the insurance pool to historical metrics of an individual member. In some implementations, a member can select a metric (e.g., 802, 804, 806 and/or 808) from graphical user interface 800 to display historical data for the selected metric. For example, when a member selects speed metric 802, graphical user interface 900 can be displayed and present speed metric data for a number (e.g., four, six, twelve, etc.) of previous months. The member can select other metrics (e.g, mileage 804, infractions 806 and/or claims 808) to display historical data for the selected metric. In some implementations, graphical user interface 900 is scrollable. For example, the member can provide input (e.g., touch gesture, keyboard or mouse input) to cause the user interface to scroll (e.g., horizontally) and display historical data for previous months (e.g., December, November, etc.).

In some implementations, historical metric data for each month (e.g., 902, 904, 906, 908, etc.) can be represented by graphical objects similar to those displayed in graphical user interface 800. For example, if the speed metric was selected, line 910 can represent a range of speed values for individuals (e.g., total population) insured by the insurance company. Graphical object 912 can represent a range of values for members of the insurance pool. Graphical object 914 can represent an average value for the insurance pool. Graphical object 916 can represent a value associated with the currently logged in member. Thus, by viewing graphical user interface 900 the member can quickly compare the historical progression of metric values for the total insured population, the insurance pool and the currently logged in insurance pool member.

In some implementations, graphical user interface 900 can include line 918 for indicating a threshold, goal or target value. For example, if average speed is the metric represented by graphical user interface 900, then line 918 can represent a average speed threshold for the insurance pool. If the average speed for the insurance pool stays below line 918 (e.g., below the threshold speed value) then the insurance pool can be eligible for discounts, rebates or other incentives. If the average speed for the insurance pool rises above the threshold speed value represented by line 918, the insurance pool may be subject to insurance premium increases or other negative consequences.

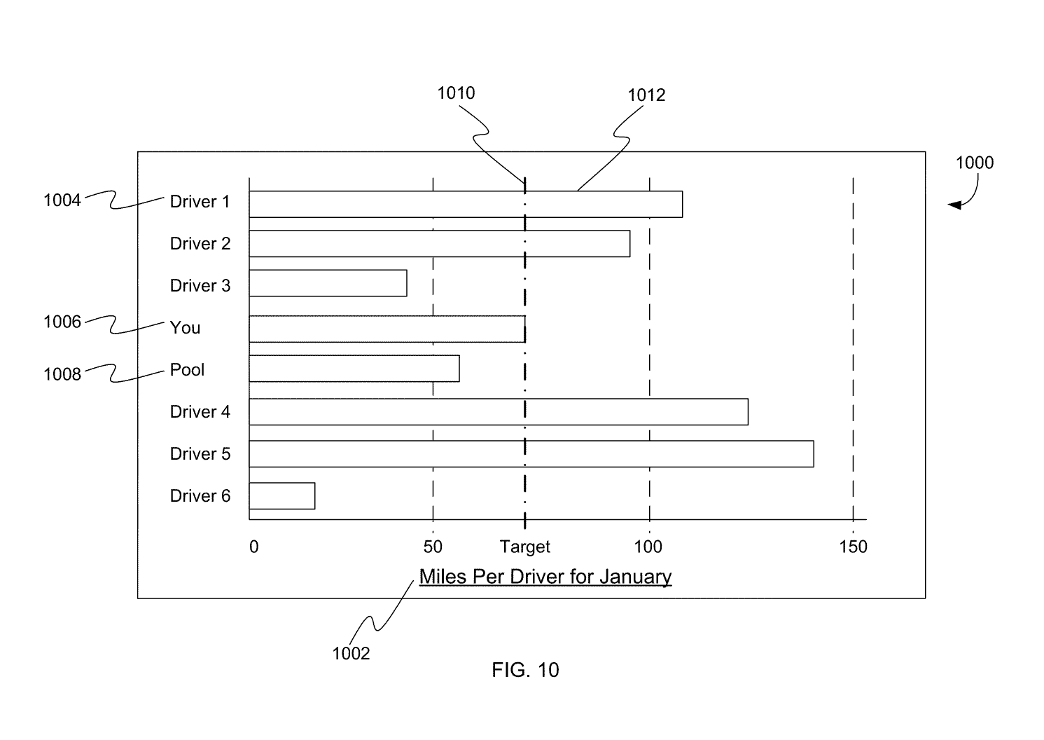

FIG. 10 illustrates an example graphical user interface 1000 displaying detailed information for members of the insurance pool for a selected month. For example, a member can select a month (e.g., 902, 904, 906 or 908) from user interface 900 to cause a detailed view of the selected metric for the month to be presented in graphical user interface 1000. For example, if average speed or miles driven was the metric displayed in user interface 900, then a detailed view of the speed or miles driven metric data collected for each member of the insurance pool for the selected month can be displayed in graphical user interface 1000. In some implementations, graphical user interface 1000 can present a bar chart, as shown in FIG. 1000. In some implementations, graphical user interface 1000 can present data using other chart representations (e.g., pie chart, dot plots, etc.).

In some implementations, graphical user interface 1000 can include a description 1002 of the metric and month displayed in graphical user interface 1000. For example, if the member selected to display the speed metric for the month of January, then the description can specify that the chart displays the average speed for the month of January. Other metrics and time periods can be displayed. In some implementations, graphical user interface 1000 can include individual driver metrics 1004 for the selected month. For example, a bar 1012 can be presented representing the metrics value collected from a member (e.g., driver 1004) of the insurance pool. In some implementations, metrics data can be displayed for the currently logged in member 1006 and for the insurance pool 1008 as a whole (e.g., averages, totals, cumulative values, etc.). In some implementations, graphical user interface 1000 can include an indication 1010 of a target value for the displayed metric. For example, the target value can represent a goal or threshold value that the members of the insurance pool should stay below for the displayed metric. If the members of the pool and/or the pool as a whole stay below the displayed target value, then the members of the insurance pool may be eligible for discounts or other benefits from the insurance company.

FIG. 11 illustrates an example graphical user interface 1100 for comparing a member's metrics to the metrics of the insurance pool. For example, graphical user interface 1100 can be invoked by selecting metric 710 or 728 from graphical user interface 700 of FIG. 7. In some implementations, graphical user interface 1100 can include information area 1102. For example, information area 1102 can include the identifier for the insurance pool and/or an identifier for the currently logged in member of the insurance pool. Information area 1102 can include status indicator 1104. For example, status indicator 1104 can indicate the current status or standing of the insurance pool member identified on graphical interface 1104, as described above with reference to status indicator 604 of FIG. 6. In some implementations, information area 1102 can present selectable graphical object 1106 for returning to a previous user interface (e.g., graphical user interface 700 of FIG. 7).

In some implementations, graphical user interface 1100 can include metric comparison area 1108. For example, area 1108 can include a metric identifier 1110 that identifies which metric (e.g., speed, mileage, infractions, claims, etc.) is currently being displayed. Area 1108 can display graphical objects 1112 and 1114 for indicating a good range of values (e.g., 1114) for the displayed metric and a bad range of values (e.g., 1112) for the displayed metric. Area 1108 can display graphical object 1116 for indicating the range of values observed or collected from the insurance pool for the displayed metric. Area 1108 can display the average value 1118 for the insurance pool and the metric value 1122 associated with the currently logged in member of the insurance pool. In some implementations, the insurance pool average and the logged in member's metric value can be indicated by graphical objects 1120 and 1124.

In some implementations, the member can specify the time period for which the metrics information will displayed on graphical user interface 1100. For example, the member can indicate a date by selecting month 1126, day 1128 and year 1130. Once the date is selected, the displayed metrics data will include metrics data from the period of time starting with the selected date and ending with the current date. In some implementations, the member can specify both start and end dates and metrics information will be presented for the time period starting with the start date and ending with the end date.

### Example Processes

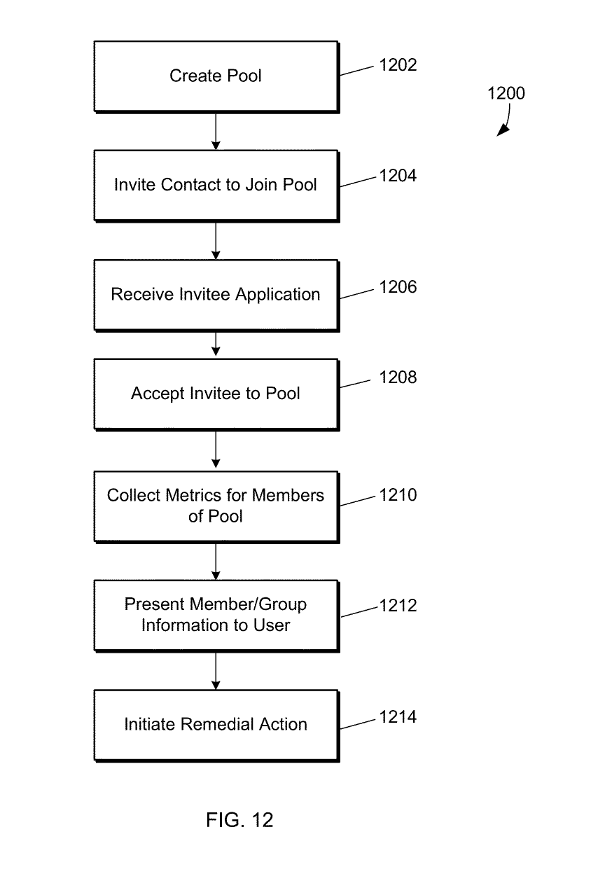

FIG. 12 is a flow diagram 1200 for self-selected insurance pool management. At step 1202, a user can create an insurance pool. For example, a user-organizer can register with an insurance agent or insurance company to create a self-selected insurance pool. The user-organizer can provide information such as credit score, driving record, income, zip code, expected miles driven, etc. so that a risk evaluation can be performed. Once the user-organizer is determined to be a good or appropriate insurance risk, the insurance pool can be created.

At step 1204, the user-organizer can invite other people (e.g., contacts) to join the insurance pool. For example, the user-organizer can send email, text messages, instant messages, or communicate with contacts through a social media website to invite others to join the insurance pool.

At step 1206, an invitee application can be received. For example, an invitee who previously received an invitation to join the insurance pool can access the insurance agent's and/or insurance company's website to apply to join the insurance pool. Through the application process the insurance agent and/or insurance company can obtain the invitee's credit score, driving record, income, zip code, expected miles driven, etc. so that a risk evaluation can be performed. If an invitee receives an invitation from more than one insurance pool, the invitee may be asked to select one of the insurance pools to join.

At step 1208, the invitee can be accepted into the insurance pool. For example, if the insurance agent and/or company determines that the invitee poses an acceptable risk, the insurance company and/or agent can approve the invitee. In some implementations, the current members of the insurance pool can vote on whether to accept the invitee into the insurance pool. In some implementations, if the number of members in an insurance pool is too small, the insurance agent and/or company can notify the members of the insurance pool and identify other insurance pools that the members might consider joining. For example, the insurance agent and/or company can identify insurance pools that can be combined based on similarities in risk associated with insuring the insurance pools. Thus, two small insurance pools can be combined into a larger insurance pool and reap the benefits of a larger membership.

In some implementations, members of the insurance pool can vote on terms of the insurance contract for the insurance pool. For example, when generating a new insurance contract or policy or renewing an insurance contract or policy, members of the insurance pool can vote on whether to accept or reject the insurance policy offered by the insurance agent or insurance company. For example, device 104, above, can present a user interface that displays the insurance policy and provides selectable graphical objects (e.g., accept button, reject button) that allows a member to vote to accept or reject the offered insurance policy. In some implementations, device 104 can provide a user interface that allows members to comment on and/or accept specific terms of an offered policy. For example, member comments can be shared with other members while negotiating for terms of a new, renewed, or modified insurance policy.

At step 1210, metrics can be collected from members of the insurance pool. For example, metrics (e.g., driving habits, traffic tickets, average speed, mileage, etc.) can be collected for each member of the insurance pool. The metrics can be used to determine the rates that each member of the insurance pool will have to pay. The metrics can be used to determine if a member of the insurance pool is no longer an acceptable risk based on the member's driving habits, accident history, etc.

At step 1212, individual and pool metrics can be presented to a user. For example, a user of the insurance agent's or insurance company's website or mobile application can log into the insurance pool's account through the insurance agent's or insurance company's server and view metrics collected for the insurance pool. The user can invoke graphical user interfaces, as described above, for viewing and comparing metrics collected for individual members and for the insurance pool as a whole.

At step 1214, the user can initiate remedial action. For example, if the user identifies another member of the insurance pool who is not behaving in a manner that benefits the insurance pool (e.g., behaving in a manner that harms the members of the insurance pool), the user can flag the harmful member to initiate remedial action, as described above.

### Example System Architecture

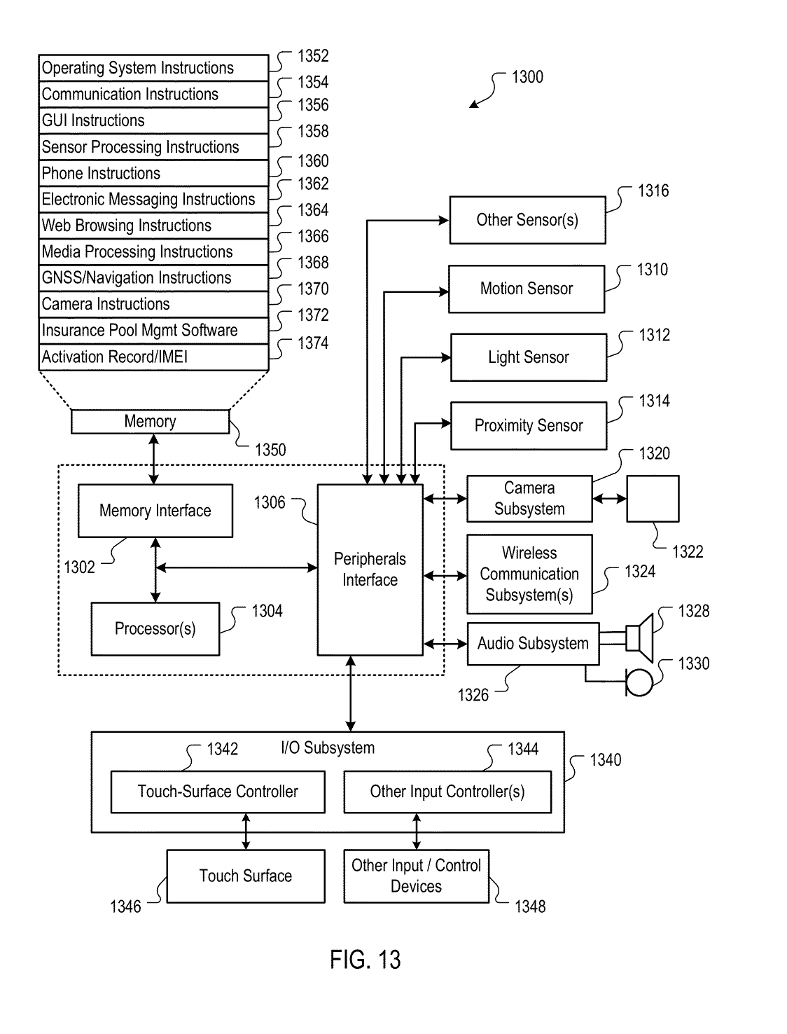

FIG. 13 is a block diagram of an example computing device 1300 that can implement the features and processes of FIGS. 1-12. The computing device 1300 can include a memory interface 1302, one or more data processors, image processors and/or central processing units 1304, and a peripherals interface 1306. The memory interface 1302, the one or more processors 1304 and/or the peripherals interface 1306 can be separate components or can be integrated in one or more integrated circuits. The various components in the computing device 1300 can be coupled by one or more communication buses or signal lines.

Sensors, devices, and subsystems can be coupled to the peripherals interface 1306 to facilitate multiple functionalities. For example, a motion sensor 1310, a light sensor 1312, and a proximity sensor 1314 can be coupled to the peripherals interface 1306 to facilitate orientation, lighting, and proximity functions. Other sensors 1316 can also be connected to the peripherals interface 1306, such as a global navigation satellite system (GNSS) (e.g., GPS receiver), a temperature sensor, a biometric sensor, or other sensing device, to facilitate related functionalities.

A camera subsystem 1320 and an optical sensor 1322, e.g., a charged coupled device (CCD) or a complementary metal-oxide semiconductor (CMOS) optical sensor, can be utilized to facilitate camera functions, such as recording photographs and video clips. The camera subsystem 1320 and the optical sensor 1322 can be used to collect images of a user to be used during authentication of a user, e.g., by performing facial recognition analysis.

Communication functions can be facilitated through one or more wireless communication subsystems 1324, which can include radio frequency receivers and transmitters and/or optical (e.g., infrared) receivers and transmitters. The specific design and implementation of the communication subsystem 1324 can depend on the communication network(s) over which the computing device 1300 is intended to operate. For example, the computing device 1300 can include communication subsystems 1324 designed to operate over a GSM network, a GPRS network, an EDGE network, a Wi-Fi or WiMax network, and a Bluetooth™ network. In particular, the wireless communication subsystems 1324 can include hosting protocols such that the device 100 can be configured as a base station for other wireless devices.

An audio subsystem 1326 can be coupled to a speaker 1328 and a microphone 1330 to facilitate voice-enabled functions, such as speaker recognition, voice replication, digital recording, and telephony functions. The I/O subsystem 1340 can include a touch-surface controller 1342 and/or other input controller(s) 1344. The touch-surface controller 1342 can be coupled to a touch surface 1346. The touch surface 1346 and touch-surface controller 1342 can, for example, detect contact and movement or break thereof using any of a plurality of touch sensitivity technologies, including but not limited to capacitive, resistive, infrared, and surface acoustic wave technologies, as well as other proximity sensor arrays or other elements for determining one or more points of contact with the touch surface 1346.

The other input controller(s) 1344 can be coupled to other input/control devices 1348, such as one or more buttons, rocker switches, thumb-wheel, infrared port, USB port, and/or a pointer device such as a stylus. The one or more buttons (not shown) can include an up/down button for volume control of the speaker 1328 and/or the microphone 1330.

In one implementation, a pressing of the button for a first duration can disengage a lock of the touch surface 1346; and a pressing of the button for a second duration that is longer than the first duration can turn power to the computing device 1300 on or off. Pressing the button for a third duration can activate a voice control, or voice command, module that enables the user to speak commands into the microphone 1330 to cause the device to execute the spoken command. The user can customize a functionality of one or more of the buttons. The touch surface 1346 can, for example, also be used to implement virtual or soft buttons and/or a keyboard.

In some implementations, the computing device 1300 can present recorded audio and/or video files, such as MP3, AAC, and MPEG files. In some implementations, the computing device 1300 can include the functionality of an MP3 player, such as an iPod™. The computing device 1300 can, therefore, include a 36-pin connector that is compatible with the iPod. Other input/output and control devices can also be used.

The memory interface 1302 can be coupled to memory 1350. The memory 1350 can include high-speed random access memory and/or non-volatile memory, such as one or more magnetic disk storage devices, one or more optical storage devices, and/or flash memory (e.g., NAND, NOR). The memory 1350 can store an operating system 1352, such as Darwin, RTXC, LINUX, UNIX, OS X, WINDOWS, or an embedded operating system such as VxWorks.

The operating system 1352 can include instructions for handling basic system services and for performing hardware dependent tasks. In some implementations, the operating system 1352 can be a kernel (e.g., UNIX kernel). In some implementations, the operating system 1352 can include instructions for performing voice authentication.

The memory 1350 can also store communication instructions 1354 to facilitate communicating with one or more additional devices, one or more computers and/or one or more servers. The memory 1350 can include graphical user interface instructions 1356 to facilitate graphic user interface processing; sensor processing instructions 1358 to facilitate sensor-related processing and functions; phone instructions 1360 to facilitate phone-related processes and functions; electronic messaging instructions 1362 to facilitate electronic-messaging related processes and functions; web browsing instructions 1364 to facilitate web browsing-related processes and functions; media processing instructions 1366 to facilitate media processing-related processes and functions; GNSS/Navigation instructions 1368 to facilitate GNSS and navigation-related processes and instructions; and/or camera instructions 1370 to facilitate camera-related processes and functions.

The memory 1350 can store other software instructions 1372 to facilitate other processes and functions, such as the insurance pool management processes and functions as described with reference to FIGS. 1-12. The memory 1350 can also store other software instructions (not shown), such as web video instructions to facilitate web video-related processes and functions; and/or web shopping instructions to facilitate web shopping-related processes and functions. In some implementations, the media processing instructions 1366 are divided into audio processing instructions and video processing instructions to facilitate audio processing-related processes and functions and video processing-related processes and functions, respectively. An activation record and International Mobile Equipment Identity (IMEI) 1374 or similar hardware identifier can also be stored in memory 1350.

Each of the above identified instructions and applications can correspond to a set of instructions for performing one or more functions described above. These instructions need not be implemented as separate software programs, procedures, or modules. The memory 1350 can include additional instructions or fewer instructions. Furthermore, various functions of the computing device 1300 can be implemented in hardware and/or in software, including in one or more signal processing and/or application specific integrated circuits.

What is claimed is:

1. A method comprising:
generating an insurance pool having a plurality of members;
obtaining insurance metrics from members of the insurance pool;
transmitting to a computing device a first metrics corresponding to a first member of the insurance pool and a second metrics corresponding to a second member of the insurance pool, wherein the computing device presents, on a user interface of the computing device, the first metrics corresponding to the first member and the second metrics corresponding to the second member of the insurance pool.

2. The method of claim 1, further comprising transmitting a number indicating a refund amount for the insurance pool, wherein the computing device presents, on the user interface, the number indicating the refund amount.

3. The method of claim 1, wherein the metrics include driving speed.

4. The method of claim 1, wherein the metrics include distance traveled.

5. The method of claim 1, wherein the metrics include traffic violations.

6. The method of claim 1, wherein the metrics include one or more roads traveled.

7. The method of claim 1, wherein the metrics include a time of day when one or more of the members drove.

8. The method of claim 1, wherein the metrics are reported by the members of the insurance pool.

9. A method comprising:
requesting metrics associated with members of an insurance pool;
receiving the metrics, wherein the metrics include a first metrics corresponding to a first member of the insurance pool and a second metrics corresponding to a second member of the insurance pool; and
displaying the first metrics and the second metric on a user interface of a computing device.

10. The method of claim 9, wherein the first metrics corresponds to a user of the computing device and the second metrics corresponds to a member of the insurance pool other than the user.

11. The method of claim 9, wherein the second metrics is associated with all members of the insurance pool.

12. The method of claim 9, wherein the second metrics is an average, summation, total or aggregation of metrics for all members of the insurance pool.

13. The method of claim 9, further comprising:
receiving a number indicating a refund earned by the insurance pool; and
presenting the number on the user interface of the computing device.

14. A non-transitory computer-readable medium including one or more sequences of instructions which, when executed by one or more processors, causes:
generating an insurance pool having a plurality of members;
obtaining insurance metrics from members of the insurance pool;
transmitting to a computing device a first metrics corresponding to a first member of the insurance pool and a second metrics corresponding to a second member of the insurance pool, wherein the computing device presents, on a user interface of the computing device, the first metrics corresponding to the first member and the second metrics corresponding to the second member of the insurance pool.

15. The non-transitory computer-readable medium of claim 14, wherein the instructions cause transmitting a number indicating a refund amount for the insurance pool, wherein the computing device presents, on the user interface, the number indicating the refund amount.

16. The non-transitory computer-readable medium of claim 14, wherein the metrics include driving speed.

17. The non-transitory computer-readable medium of claim 14, wherein the metrics include distance traveled.

18. The non-transitory computer-readable medium of claim 14, wherein the metrics include traffic violations.

19. The non-transitory computer-readable medium of claim 14, wherein the metrics include one or more roads traveled.

20. The non-transitory computer-readable medium of claim 14, wherein the metrics include a time of day when one or more of the members drove.

21. The non-transitory computer-readable medium of claim 14, wherein the metrics are reported by the members of the insurance pool.

22. A non-transitory computer-readable medium including one or more sequences of instructions which, when executed by one or more processors, causes:
requesting metrics associated with members of an insurance pool;
receiving the metrics, wherein the metrics include a first metrics corresponding to a first member of the insurance pool and a second metrics corresponding to a second member of the insurance pool; and
displaying the first metrics and the second metric on a user interface of a computing device.

23. The non-transitory computer-readable medium of claim 22, wherein the first metrics corresponds to a user of the computing device and the second metrics corresponds to a member of the insurance pool other than the user.

24. The non-transitory computer-readable medium of claim 22, wherein the second metrics is associated with all members of the insurance pool.

25. The non-transitory computer-readable medium of claim 22, wherein the second metrics is an average, summation, total or aggregation of metrics for all members of the insurance pool.

26. The non-transitory computer-readable medium of claim 22, wherein the instructions cause:
receiving a number indicating a refund earned by the insurance pool; and
presenting the number on the user interface of the computing device.

27. A system comprising:
one or more processors; and
a computer-readable medium including one or more sequences of instructions which, when executed by one or more processors, causes:
generating an insurance pool having a plurality of members;
obtaining insurance metrics from members of the insurance pool;
transmitting to a computing device a first metrics corresponding to a first member of the insurance pool and a second metrics corresponding to a second member of the insurance pool, wherein the computing device presents, on a user interface of the computing device, the first metrics corresponding to the first member and the second metrics corresponding to the second member of the insurance pool.

28. The system of claim 27, wherein the instructions cause transmitting a number indicating a refund amount for the insurance pool, wherein the computing device presents, on the user interface, the number indicating the refund amount.

29. The system of claim 27, wherein the metrics include driving speed.

30. The system of claim 27, wherein the metrics include distance traveled.

31. The system of claim 27, wherein the metrics include traffic violations.

32. The system of claim 27, wherein the metrics include one or more roads traveled.

33. The system of claim 27, wherein the metrics include a time of day when one or more of the members drove.

34. The system of claim 27, wherein the metrics are reported by the members of the insurance pool.

35. A system comprising:
one or more processors; and
a non-transitory computer-readable medium including one or more sequences of instructions which, when executed by one or more processors, causes:
requesting metrics associated with members of an insurance pool;
receiving the metrics, wherein the metrics include a first metrics corresponding to a first member of the insurance pool and a second metrics corresponding to a second member of the insurance pool; and
displaying the first metrics and the second metric on a user interface of a computing device.

36. The system of claim 35, wherein the first metrics corresponds to a user of the computing device and the second metrics corresponds to a member of the insurance pool other than the user.

37. The system of claim 35, wherein the second metrics is associated with all members of the insurance pool.

38. The system of claim 35, wherein the second metrics is an average, summation, total or aggregation of metrics for all members of the insurance pool.

39. The system of claim 35, wherein the instructions cause:
receiving a number indicating a refund earned by the insurance pool; and
presenting the number on the user interface of the computing device.
